(19) United States
(12) Patent Application Publication
(10) Pub. No.: US 2013/0149502 A1
(43) Pub. Date: Jun. 13, 2013

(54) Double-Sided Multi-Layer Adhesive

(71) Applicants: William R. Dudley, Geneseo, NY (US); Audrey A. Sherman, St. Paul, MN (US); Scott M. Tapio, Falcon Heights, MN (US)

(72) Inventors: William R. Dudley, Geneseo, NY (US); Audrey A. Sherman, St. Paul, MN (US); Scott M. Tapio, Falcon Heights, MN (US)

(73) Assignee: 3M INNOVATIVE PROPERTIES COMPANY, ST. PAUL, MN (US)

(21) Appl. No.: 13/817,739

(22) PCT Filed: Aug. 23, 2011
(86) PCT No.: PCT/US11/48821

§ 371 Date: Feb. 19, 2013

Related U.S. Application Data
(60) Provisional application No. 61/377,212, filed on Aug. 26, 2010.

(51) Int. Cl. C09J 167/03; C09J 167/00; C09J 133/00

(52) U.S. Cl. CPC C09J 167/03; C09J 133/00; C09J 167/00
USPC 428/172; 428/355 CN; 427/207.1; 428/354; 427/208.8

(57) ABSTRACT

Methods for preparing double-sided multi-layer adhesives, double-sided multi-layer adhesives and articles prepared with double-sided multi-layer adhesives are disclosed. The methods for preparing double-sided multi-layer adhesives include providing a first fluid, the first fluid including a polymeric adhesive composition solution or dispersion, providing a second fluid, the second fluid including a curable composition, coating the first fluid and the second fluid onto a substrate, and curing the curable composition to form a double-sided multi-layer adhesive. The coating of the first fluid and the second fluid onto a substrate may include simultaneous slot die coating of the two fluids or sequential coating of the two fluids. The curable composition layer is cured to form a multi-layer adhesive article. The formed multi-layer adhesive article may be a transfer tape.

### FIELD OF THE DISCLOSURE

The present disclosure relates generally to the field of adhesives, specifically to the field of double-sided multi-layer pressure sensitive adhesives and tapes and articles prepared therefrom.

### BACKGROUND

Adhesives have been used for a variety of marking, holding, protecting, sealing and masking purposes. Adhesive tapes generally comprise a backing, or substrate, and an adhesive. One type of adhesive, a pressure sensitive adhesive, is particularly preferred for many applications.

Pressure sensitive adhesives are well known to one of ordinary skill in the art to possess certain properties at room temperature including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are natural rubber, synthetic rubbers (e.g., styrene/butadiene copolymers (SBR) and styrene/isoprene/styrene (SIS) block copolymers), various (meth)acrylate (e.g., acrylate and methacrylate) copolymers and silicones. Each of these classes of materials has advantages and disadvantages.

### SUMMARY

Disclosed herein are double-sided multi-layer adhesives comprising at least two layers of pressure sensitive adhesive, the first layer comprising a first pressure sensitive adhesive composition, and the second layer comprising a second pressure sensitive adhesive composition comprising a cured mixture. The cured mixture comprises at least one X-B-X reactive oligomer, wherein X comprises an ethylenically unsaturated group, and B comprises a non-siloxane containing segmented urea-based unit, or a non-siloxane containing segmented urethane-based unit.

Also disclosed are methods for preparing double-sided multi-layer adhesives, double-sided multi-layer adhesives and articles prepared with double-sided multi-layer adhesives. Methods for preparing double-sided multi-layer adhesives comprise providing a first fluid, the first fluid comprising a polymeric adhesive composition solution or dispersion, providing a second fluid, the second fluid comprising a curable composition, coating the first fluid and the second fluid onto a substrate, and curing the curable composition. The curable composition comprises at least one X-B-X reactive oligomer, wherein X comprises an ethylenically unsaturated group, and B comprises a non-siloxane containing segmented urea-based unit, a non-siloxane containing segmented urethane-based unit, or a siloxane-based unit, and an initiator. In some embodiments, the coating of the first fluid and the second fluid onto a substrate comprises simultaneous slot die coating of the two fluids. In other embodiments, the coating of the first fluid and the second fluid onto a substrate comprises sequential coating of the two fluids.

Adhesive articles are also disclosed. The adhesive articles comprise a double-sided multi-layer adhesive comprising at least two layers of pressure sensitive adhesive and a substrate. The first layer comprises a first pressure sensitive adhesive, and the second layer comprises a pressure sensitive adhesive comprising a cured mixture. The cured mixture comprises at least one X-B-X reactive oligomer, wherein X comprises an ethylenically unsaturated group, and B comprises a non-siloxane containing segmented urea-based unit, or a non-siloxane containing urethane-based unit. The substrate may comprise an optically active film.

### BRIEF DESCRIPTION OF THE DRAWINGS

FIG. 1 shows a schematic of an exemplary multi-layer coating method of the disclosure.

### DETAILED DESCRIPTION

Double-sided tapes, also called “transfer tapes” are adhesive tapes that have adhesive on both exposed surfaces. In some transfer tapes, the exposed surfaces are simply the two surfaces of a single adhesive layer. Other transfer tapes are multi-layer transfer tapes with at least two adhesive layers that may be the same or different, and in some instances intervening layers that may not be adhesive layers. For example, a multi-layer transfer tape may be a 3 layer construction with an adhesive layer, a film layer and another adhesive layer. The film layer can provide handling and/or tear strength or other desirable properties. In this disclosure, multi-layer double-sided adhesives are prepared that comprise at least two layers of pressure sensitive adhesive. Typically there are no intervening layers.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “adhesive” as used herein refers to polymeric compositions useful to adhere together two adherends. Examples of adhesives are heat activated adhesives and pressure sensitive adhesives.

Heat activated adhesives are non-tacky at room temperature but become tacky and capable of bonding to a substrate at elevated temperatures. These adhesives usually have a T_{g} (glass transition temperature) or melting point (Tₘ) above room temperature. When the temperature is elevated above the T_{g} or Tₘ, the storage modulus usually decreases and the adhesive becomes tacky.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The terms “non-silicone” or “non-siloxane” as used herein refer to segmented copolymers or units of segmented copolymers that are free of silicone units. The terms silicone or siloxane are used interchangeably and refer to units with dialkyl or diaryl siloxane (—SiR₂O—) repeating units.

The term “urea-based” as used herein refers to macromolecules that are segmented copolymers which contain at least one urea linkage. The urea group has the general structure (—^{a}RN—(CO)—NR^{b}—) where (CO) defines a carbonyl group C═O, and R^{a} and R^{b} are each independently a hydrogen or a hydrocarbon group.

The term “urethane-based” as used herein refers to macromolecules that are copolymers or segmented copolymers which contain at least one urethane linkage. The urethane group has the general structure (—O—(CO)—NR—) where (CO) defines a carbonyl group C═O, and R is hydrogen or a hydrocarbon group.

The term “segmented copolymer” refers to a copolymer of linked segments, each segment constitutes primarily a single structural unit or type of repeating unit. For example, a polyoxyalkylene segmented copolymer may have the following structure:

—CH₂CH₂(OCH₂CH₂)ₙOCH₂CH₂-A-CH₂CH₂(OCH₂CH₂)ₙOCH₂CH₂—

where A is the linkage between the two polyoxyalkylene segments.

The term “reactive oligomer” as used herein refers to a macromolecule which contains terminal free radically polymerizable groups and at least 2 segments which are linked. “Urea-based reactive oligomers” are macromolecules which contain terminal free radical polymerizable groups and at least 2 segments which are linked by urea linkages.

The term “hydrocarbon group” as used herein refers to any monovalent group that contains primarily or exclusively carbon and hydrogen atoms. Alkyl and aryl groups are examples of hydrocarbon groups.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “heteroalkylene” refers to a divalent group that includes at least two alkylene groups connected by a thio, oxy, or —NR— where R is alkyl. The heteroalkylene can be linear, branched, cyclic, substituted with alkyl groups, or combinations thereof. Some heteroalkylenes are poloxyyalkylenes where the heteroatom is oxygen such as for example,

—CH₂CH₂(OCH₂CH₂)ₙOCH₂CH₂—.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “heteroarylene” refers to a divalent group that is carbocyclic and aromatic and contains heteroatoms such as sulfur, oxygen, nitrogen or halogens such as fluorine, chlorine, bromine or iodine.

The term “aralkylene” refers to a divalent group of formula —R^{a}—Ar^{a}— where R^{a} is an alkylene and Ar^{a} is an arylene (i.e., an alkylene is bonded to an arylene).

The term “(meth)acrylate” refers to monomeric acrylic or methacrylic esters of alcohols. Acrylate and methacrylate monomers or oligomers are referred to collectively herein as “(meth)acrylates”.

The terms “free radically polymerizable” and “ethylenically unsaturated” are used interchangeably and refer to a reactive group which contains a carbon-carbon double bond which is able to be polymerized via a free radical polymerization mechanism.

Unless otherwise indicated, “optically transparent” refers to an article, film or adhesive that has a high light transmittance over at least a portion of the visible light spectrum (about 400 to about 700 nm). The term “transparent film” refers to a film having a thickness and when the film is disposed on a substrate, an image (disposed on or adjacent to the substrate) is visible through the thickness of the transparent film. In many embodiments, a transparent film allows the image to be seen through the thickness of the film without substantial loss of image clarity. In some embodiments, the transparent film has a matte or glossy finish.

Unless otherwise indicated, “optically clear” refers to an adhesive or article that has a high light transmittance over at least a portion of the visible light spectrum (about 400 to about 700 nm), and that exhibits low haze.

Unless otherwise indicated, “self wetting” refers to an adhesive which is very soft and conformable and is able to be applied with very low lamination pressure. Such adhesives exhibit spontaneous wet out to surfaces.

Unless otherwise indicated, “removable” refers to an adhesive that has relatively low initial adhesion (permitting temporary removability from and repositionability on a substrate after application), with a building of adhesion over time (to form a sufficiently strong bond), but remains “removable” i.e. the adhesion does not build beyond the point where it is permanently cleanly removable from the substrate.

Disclosed herein are methods of preparing double-sided multi-layer adhesives comprising at least two layers of pressure sensitive adhesive. The method comprises providing a first fluid and a second fluid. The first fluid comprises a pressure sensitive adhesive solution or dispersion in the form of a layer. The second fluid comprises a curable composition. The curable composition is coated onto the first fluid pressure sensitive adhesive layer and cured to form a second pressure sensitive adhesive layer.

The first fluid layer comprises a first pressure sensitive adhesive polymer dissolved or suspended in a liquid media. The liquid media may comprise water, an organic solvent, or a combination thereof. Examples of suitable organic solvents include: alcohols such as methanol, ethanol, isopropanol and the like; aliphatic hydrocarbons such as hexanes, heptanes, petroleum ether and the like; aromatic solvents such as benzene, toluene, and the like; ethers such as diethyl ether, THF (tetrahydrofuran), and the like; esters such as ethyl acetate and the like; ketones such as acetone, MEK (methyl ethyl ketone) and the like.

The first pressure sensitive adhesive generally comprises a polymeric and/or oligomeric adhesive prepared by polymerizing one or more monomers. Examples of suitable pressure sensitive adhesives include (meth)acrylate pressure sensitive adhesives and siloxane pressure sensitive adhesives. In some embodiments, particularly embodiments involving optical elements and optical applications, it is desirable that the first pressure sensitive adhesive be optically clear.

To achieve pressure sensitive adhesive characteristics, the corresponding copolymer can be tailored to have a resultant glass transition temperature (T_{g}) of less than about 0° C. Particularly suitable pressure sensitive adhesive copolymers are (meth)acrylate copolymers. Such copolymers typically are derived from monomers comprising about 40% by weight to about 98% by weight, often at least 70% by weight, or at least 85% by weight, or even about 90% by weight, of at least one alkyl(meth)acrylate monomer that, as a homopolymer, has a T_{g} of less than about 0° C.

Examples of such alkyl(meth)acrylate monomers are those in which the alkyl groups comprise from about 4 carbon atoms to about 12 carbon atoms and include, but are not limited to, n-butyl acrylate, 2-ethylhexyl acrylate, isooctyl acrylate, isononyl acrylate, isodecyl acrylate, and mixtures thereof. Optionally, other vinyl monomers and alkyl(meth)acrylate monomers which, as homopolymers, have a T_{g} greater than 0° C., such as methyl acrylate, methyl methacrylate, isobornyl acrylate, vinyl acetate, styrene, and the like, may be utilized in conjunction with one or more of the low T_{g} alkyl(meth)acrylate monomers and copolymerizable basic or acidic monomers, provided that the T_{g} of the resultant (meth)acrylate copolymer is less than about 0° C. In some embodiments the (meth)acrylate copolymer is a basic copolymer, in other embodiments the (meth)acrylate copolymer is an acidic copolymer, and in still other embodiments the (meth)acrylate copolymer may contain both basic and acidic monomers or it may contain neither. It may be desirable, in some embodiments, for the first pressure sensitive adhesive polymer to contain acidic functionality so that it can form an acid-base interaction with the urea or urethane groups of the polymer formed by the curable composition layer. This acid-base interaction between the polymers is a Lewis acid-base type interaction. Lewis acid-base type interactions require that one component be an electron acceptor (acid) and the other an electron donor (base). The electron donor provides an unshared pair of electrons and the electron acceptor furnishes an orbital system that can accommodate the additional unshared pair of electrons. In this instance acid groups, typically carboxylic acid groups in the first pressure sensitive adhesive polymer interact with the unshared electron pairs of the urea or urethane groups.

In some embodiments, it is desirable to use (meth)acrylate monomers that are free of alkoxy groups. Alkoxy groups are understood by those skilled in the art.

When used, basic (meth)acrylate copolymers useful as the pressure sensitive adhesive matrix typically are derived from basic monomers comprising about 2% by weight to about 50% by weight, or about 5% by weight to about 30% by weight, of a copolymerizable basic monomer. Exemplary basic monomers include N,N-dimethylaminopropyl methacrylamide (DMAPMAm); N,N-diethylaminopropyl methacrylamide (DEAPMAm); N,N-dimethylaminoethyl acrylate (DMAEA); N,N-diethylaminoethyl acrylate (DEAEA); N,N-dimethylaminopropyl acrylate (DMAPA); N,N-diethylaminopropyl acrylate (DEAPA); N,N-dimethylaminoethyl methacrylate (DMAEMA); N,N-diethylaminoethyl methacrylate (DEAEMA); N,N-dimethylaminoethyl acrylamide (DMAEAm); N,N-dimethylaminoethyl methacrylamide (DMAEMAm); N,N-diethylaminoethyl acrylamide (DEAEAm); N,N-diethylaminoethyl methacrylamide (DEAEMAm); N,N-dimethylaminoethyl vinyl ether (DMAEVE); N,N-diethylaminoethyl vinyl ether (DEAEVE); and mixtures thereof. Other useful basic monomers include vinylpyridine, vinylimidazole, tertiary amino-functionalized styrene (e.g., 4-(N,N-dimethylamino)-styrene (DMAS), 4-(N,N-diethylamino)-styrene (DEAS)), N-vinylpyrrolidone, N-vinylcaprolactam, acrylonitrile, N-vinylformamide, (meth)acrylamide, and mixtures thereof.

When used to form the pressure sensitive adhesive matrix, acidic (meth)acrylate copolymers typically are derived from acidic monomers comprising about 2% by weight to about 30% by weight, or about 2% by weight to about 15% by weight, of a copolymerizable acidic monomer. Useful acidic monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, beta-carboxyethyl acrylate, 2-sulfoethyl methacrylate, styrenesulfonic acid, 2-acrylamido-2-methylpropanesulfonic acid, vinylphosphonic acid, and the like, and mixtures thereof. Due to their availability, typically ethylenically unsaturated carboxylic acids are used.

In certain embodiments, the poly(meth)acrylic pressure sensitive adhesive matrix is derived from between about 1 and about 20 weight percent of acrylic acid and between about 99 and about 80 weight percent of at least one of isooctyl acrylate, 2-ethylhexyl acrylate or n-butyl acrylate composition. In some embodiments, the pressure sensitive adhesive matrix is derived from between about 2 and about 10 weight percent acrylic acid and between about 90 and about 98 weight percent of at least one of isooctyl acrylate, 2-ethylhexyl acrylate or n-butyl acrylate composition.

Another useful class of optically clear (meth)acrylate-based pressure sensitive adhesives are those which are (meth)acrylic block copolymers. Such copolymers may contain only (meth)acrylate monomers or may contain other co-monomers such as styrenes. Examples of such pressure sensitive adhesives are described, for example in U.S. Pat. No. 7,255,920 (Everaerts et al.).

The pressure sensitive adhesive may be inherently tacky. If desired, tackifiers may be added to a base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, curing agents, polymer additives, thickening agents, chain transfer agents and other additives provided that they do not reduce the optical clarity of the pressure sensitive adhesive.

In some embodiments it is desirable for the composition to contain a crosslinking agent. The choice of crosslinking agent depends upon the nature of polymer or copolymer which one wishes to crosslink. The crosslinking agent is used in an effective amount, by which is meant an amount that is sufficient to cause crosslinking of the pressure sensitive adhesive to provide adequate cohesive strength to produce the desired final adhesion properties to the substrate of interest. Generally, when used, the crosslinking agent is used in an amount of about 0.1 part to about 10 parts by weight, based on the total amount of monomers.

One class of useful crosslinking agents include multifunctional (meth)acrylate species. Multifunctional (meth)acrylates include tri(meth)acrylates and di(meth)acrylates (that is, compounds comprising three or two (meth)acrylate groups). Typically di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

Another useful class of crosslinking agents contain functionality which is reactive with carboxylic acid groups on the acrylic copolymer. Examples of such crosslinkers include multifunctional aziridine, isocyanate, epoxy, and carbodiimide compounds. Examples of aziridine-type crosslinkers include, for example 1,4-bis(ethyleneiminocarbonylamino)benzene, 4,4′-bis(ethyleneiminocarbonylamino)diphenylmethane, 1,8-bis(ethyleneiminocarbonylamino)octane, and 1,1′-(1,3-phenylene dicarbonyl)-bis-(2-methylaziridine). The aziridine crosslinker 1,1′-(1,3-phenylene dicarbonyl)-bis-(2-methylaziridine) (CAS No. 7652-64-4), referred to herein as “Bisamide” is particularly useful. Common polyfunctional isocyanate crosslinkers include, for example, trimethylolpropane toluene diisocyanate, tolylene diisocyanate, and hexamethylene diisocyanate.

In some embodiments, the first pressure sensitive adhesive may comprise a siloxane pressure sensitive adhesive. Suitable siloxane pressure sensitive adhesives include, for example, those described in U.S. Pat. Nos. 5,527,578 and 5,858,545; and PCT Publication No. WO 00/02966. Specific examples include polydiorganosiloxane polyurea copolymers and blends thereof, such as those described in U.S. Pat. No. 6,007,914, and polysiloxane-polyalkylene block copolymers. Other examples of siloxane pressure sensitive adhesives include those formed from silanols, silicone hydrides, siloxanes, epoxides, and (meth)acrylates. When the siloxane pressure sensitive adhesive is prepared from (meth)acrylate-functional siloxanes, the adhesive is sometimes referred to as a siloxane(meth)acrylate. The first pressure sensitive adhesive may also comprise a fluorochemical.

The second fluid comprises a curable composition. The curable composition comprises free radically polymerizable components and may also contain non-free radically polymerizable components. The curable composition comprises at least one X-B-X reactive oligomer, wherein X comprises an ethylenically unsaturated group, and B comprises a non-siloxane segmented urea-based, a non-siloxane segmented urethane-based unit, or a siloxane-based unit. Depending upon the nature of the components in the curable composition, the curable composition may contain a solvent or it may be a 100% solids solventless composition.

In some embodiments, the disclosure includes a curable composition containing at least one X-B-X reactive oligomer, in which X comprises an ethylenically unsaturated group, and B comprises a non-siloxane segmented urea-based unit. Examples of suitable X-B-X reactive oligomers are described, for example, in PCT Publication WO 2009/085662. The urea-based unit may contain polyoxyalkylene groups.

Non-siloxane urea-based polyamines are used to prepare the non-siloxane urea-based X-B-X reactive oligomers. The preparation of non-siloxane urea-based polyamines may be achieved through the reaction of polyamines with carbonates. A wide variety of different types of polyamines may be used. In some embodiments the polyamines are polyoxyalkylene polyamines. Such polyamines are also sometimes referred to as polyether polyamines.

The polyoxyalkylene polyamine may be, for example, a polyoxyethylene polyamine, polyoxypropylene polyamine, polyoxytetramethylene polyamine, or mixtures thereof. Polyoxyethylene polyamine may be especially useful when preparing the adhesive for medical applications, for example, where high vapor transfer medium may be desirable.

Many polyoxyalkylene polyamines are commercially available. For example, polyoxyalkylene diamines are available under trade designations such as D-230, D-400, D-2000, D-4000, DU-700, ED-2001 and EDR-148 (available from Huntsman Chemical; Houston, Tex. under the family trade designation JEFFAMINE). Polyoxyalkylene triamines are available under trade designations such as T-3000 and T-5000 (available from Huntsman Chemical; Houston, Tex.).

A variety of different carbonates may be reacted with the polyamine to give the non-siloxane urea-based polyamine. Suitable carbonates include alkyl, aryl and mixed alkyl-aryl carbonates. Examples include carbonates such as ethylene carbonate, 1,2- or 1,3-propylene carbonate, diphenyl carbonate, ditolyl carbonate, dinaphthyl carbonate, ethyl phenyl carbonate, dibenzyl carbonate, dimethyl carbonate, diethyl carbonate, dipropyl carbonate, dibutyl carbonate, dihexyl carbonate, and the like. In some embodiments the carbonate is a diaryl carbonate, such as for example, diphenyl carbonate.

In some embodiments the polyoxyalkylene polyamine is a polyoxyalkylene diamine which yields a non-siloxane urea-based diamine. In one specific embodiment, the reaction of 4 equivalents of polyoxyalkylene diamine with 3 equivalent of carbonate yields a chain-extended, non-siloxane urea-based diamine and 6 equivalents of an alcohol byproduct, as shown in reaction scheme I below (R in this case is an aryl group such as phenyl and n is an integer of 30-40):

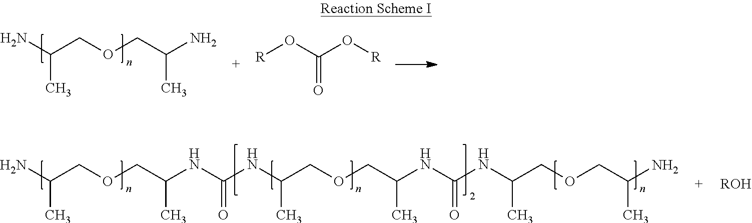

A reaction scheme such as shown for Reaction Scheme I is sometimes called a “chain extension reaction” because the starting material is a diamine and the product is a longer chain diamine. The chain extension reaction shown in Reaction Scheme I can be used to give higher or lower molecular weight by varying the equivalents of diamine and carbonate used.

The non-siloxane urea-based reactive oligomers of this disclosure have the general structure X-B-X. In this structure the B unit is a non-siloxane urea-based group and the X groups are ethylenically unsaturated groups.

The B unit is non-siloxane and contains at least one urea group and may also contain a variety of other groups such as urethane groups, amide groups, ether groups, carbonyl groups, ester groups, alkylene groups, heteroalkylene groups, arylene groups, heteroarylene groups, aralkylene groups, or combinations thereof. The composition of the B unit results from the choice of precursor compounds used to form the X-B-X reactive oligomer.

To prepare the non-siloxane urea-based reactive oligomers of this disclosure, two different reaction pathways may be used. In the first reaction pathway a non-siloxane urea-based polyamine such as a non-siloxane urea-based diamine is reacted with an X-Z compound. The Z group of the X-Z compound is an amine reactive group and the X group is an ethylenically unsaturated group. A variety of Z groups are useful for this reaction pathway including carboxylic acids, isocyantes, epoxies, azlactones and anhydrides. The X group contains an ethylenically unsaturated group (i.e. a carbon-carbon double bond) and is linked to the Z group. The link between the X and Z groups may be a single bond or it may be a linking group. The linking group may be an alkylene group, a heteroalkylene group, an arylene group, a heteroarylene group, an aralkylene group, or a combination thereof.

Examples of X-Z compounds include isocyanatoethyl methacrylate, alkenyl azlactones such as vinyl dimethyl azlactone and isopropenyl dimethyl azlactone, m-isopropenyl-α,α-dimethyl benzyl isocyanate, and acryloyl ethyl carbonic anhydride. In some embodiments the X-Z compound is isocyanatoethyl methacrylate or vinyl dimethyl azlactone.

In some embodiments the non-siloxane urea-based diamine is reacted with an isocyanate functional (meth)acrylate as shown in reaction scheme II below in which the R¹ group is an alkylene linking group such as a —CH₂CH₂— group and n is an integer of 30-40:

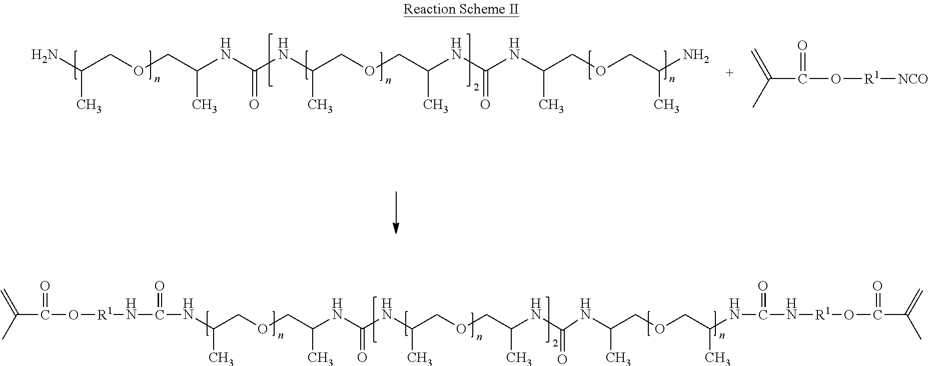

In some embodiments the non-siloxane urea-based diamine is reacted with an azlactone as shown in reaction scheme III below in which the R² groups are alkyl groups such as methyl groups and n is as previously defined:

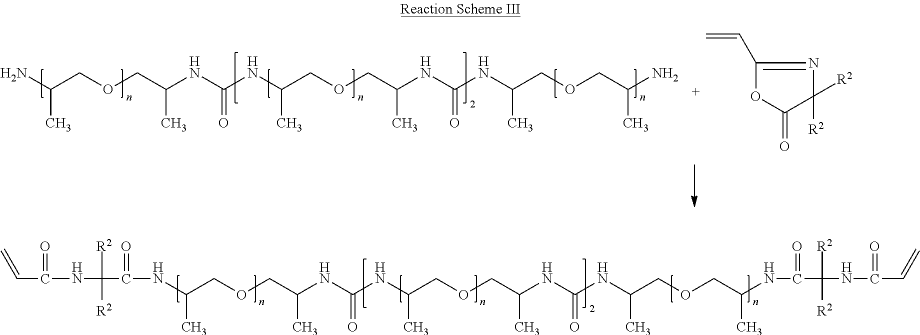

A second reaction pathway to obtain the non-siloxane urea-based reactive oligomers of this disclosure involves a two step reaction sequence. In the first step a non-siloxane urea-based diamine is capped with a difunctional Z-W-Z compound. The Z groups of the Z-W-Z compound are amine reactive groups. A variety of Z groups are useful for this reaction pathway including carboxylic acids, isocyantes, epoxies, and azlactones. Typically Z is an isocyanate. The W group of the Z-W-Z compound is a linking group that links the Z groups. The W group may be an alkylene group, a heteroalkylene group, an arylene group, a heteroarylene group, an aralkylene group, or a combination thereof.

Examples of useful Z-W-Z compounds are diisocyanates. Examples of such diisocyanates include, but are not limited to, aromatic diisocyanates, such as 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate), methylenediphenylene-4,4′-diisocyanate, polycarbodiimide-modified methylenediphenylene diisocyanate, (4,4′-diisocyanato-3,3′,5,5′-tetraethyl)biphenylmethane, 4,4′-diisocyanato-3,3′-dimethoxybiphenyl, 5-chloro-2,4-toluene diisocyanate, 1-chloromethyl-2,4-diisocyanato benzene, aromatic-aliphatic diisocyanates such as m-xylylene diisocyanate, tetramethyl-m-xylylene diisocyanate, aliphatic diisocyanates, such as 1,4-diisocyanatobutane, 1,6-diisocyanatohexane, 1,12-diisocyanatododecane, 2-methyl-1,5diisocyanatopentane, and cycloaliphatic diisocyanates such as methylene-dicyclohexylene-4,4′-diisocyanate, and 3-isocyanatomethyl-3,5,5-trimethyl-cyclohexyl isocyanate (isophorone diisocyanate),

Typically the Z-W-Z compound is an aliphatic or cycloaliphatic diisocyanate such as 1,6-diisocyanatohexane or isophorone diisocyanate.

For example, a non-siloxane urea-based diamine may be reacted with a diisocyanate to a generate a non-siloxane urea-based diisocyanate. The non-siloxane urea-based diisocyanate can then be further reacted with a Y-X compound. The Y of the Y-X compound is an isocyanate reactive group such as an alcohol, an amine or a mercaptan. Typically the Y group is an alcohol. The X group contains an ethylenically unsaturated group (i.e. a carbon-carbon double bond) and is linked to the Y group. The link between the X and Y groups may be a single bond or it may be a linking group. The linking group may be an alkylene group, a heteroalkylene group, an arylene group, a heteroarylene group, an aralkylene group, or a combination thereof.

Examples of useful Y-X compounds include hydroxyl functional (meth)acrylates such as (meth)acrylic acid monoesters of polyhydroxy alkyl alcohols such as 1,2-ethanediol, 1,2-propanediol, 1,3-propane diol, the various butyl diols, the various hexanediols, glycerol, such that the resulting esters are referred to as hydroxyalkyl(meth)acrylates. In some embodiments, the Y-X compound is hydroxylethyl acrylate.

In some embodiments the non-siloxane urea-based diamine is reacted with a diisocyanate to form a non-siloxane urea-based diisocyanate. This non-siloxane urea-based diisocyanate is then reacted with a hydroxyl functional (meth)acrylate as shown in reaction scheme IV below in which R³ may be a substituted or unsubstituted alkylene or arylene group (in this specific embodiment OCN—R³—NCO is isophorone diisocyanate) and R⁴ is an alkylene linking group such as a —CH₂CH₂— group, n is as previously defined, and the catalyst is dibutyltin dilaurate:

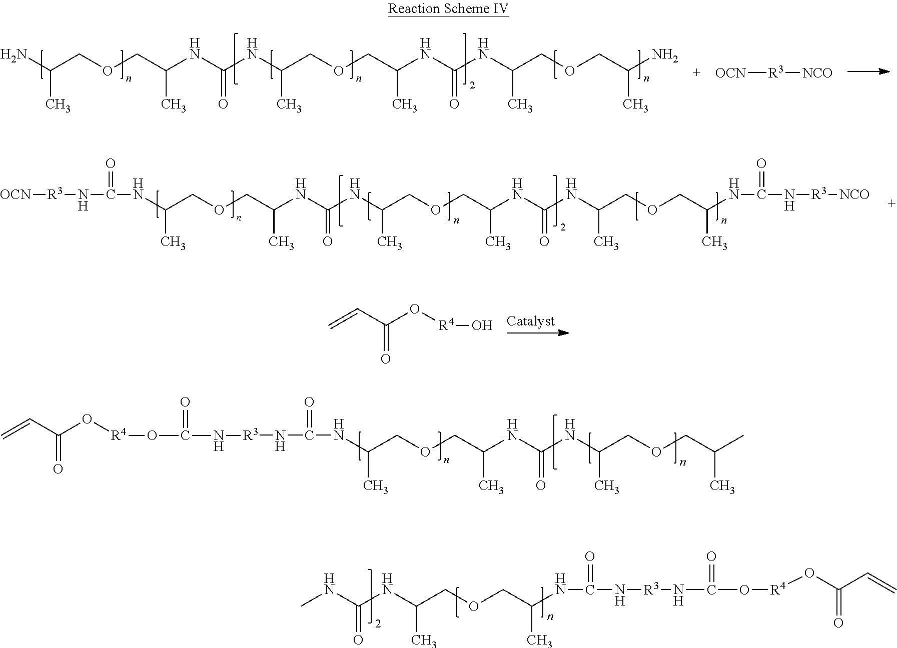

In some embodiments, the disclosure includes a curable reaction mixture containing at least one X-B-X reactive oligomer, in which X comprises an ethylenically unsaturated group, and B comprises a non-siloxane segmented urethane-based unit. Examples of suitable X-B-X reactive oligomers are described, for example, in pending U.S. Patent Application No. 61/178,514, “Urethane-based Pressure Sensitive Adhesives”, filed May 15, 2009.

Typically, urethane-based reactive oligomers comprise urethane-based units where the units -B- comprise units of the general structure -A-D-A-, where the D unit is a non-siloxane group with a number average molecular weight of 5,000 grams/mole or greater and the A groups are urethane linkages. Therefore, the typical non-siloxane urethane-based reactive oligomers of this disclosure have the general structure X-A-D-A-X.

The reactive oligomers described by the formula X-A-D-A-X may be a mixture of reactive oligomers. The mixture of reactive oligomers may include reactive oligomers which have a functionality of less than 2. These oligomers can be described by the general structure X-A-D-Y where X, A, and D are as previously described and Y is a group that is not free radically polymerizable and may or may not contain a urethane linkage to the D unit. An example of a Y group is a hydroxyl (—OH) group which could be the unreacted remnant from a HO-D-OH precursor. The presence of X-A-D-Y components along with the X-A-D-A-X components can give a branched polymer when the mixture is polymerized because the unreactive Y groups do not become part of polymer backbone.

This branching, due to the use of monomers that are not completely difunctional, is a common feature in many polyurethane adhesives because until recently, purely difunctional diols of high molecular weight were not available. In the adhesives of the present disclosure, this branching, when present, does not produce undesirable properties, but rather may even be desirable. For example, branching may assist in producing adhesives which have the desirable siloxane-like properties such as self wetting.

The X-A-D-A-X reactive oligomers may be prepared, for example, by the reaction of a hydroxyl-functional precursor of general formula HO-D-OH with 2 equivalents of an isocyanate-functional precursor of the general formula Z-X, where the Z group is isocyanate-functional and the X groups are ethylenically unsaturated groups. The isocyanate functionality of the Z group reacts with a hydroxyl group of the polyol to form the urethane linkage.

A wide variety of HO-D-OH precursors may be used. The HO-D-OH may be polyol or it may be a hydroxyl-capped prepolymer such as a polyurethane, polyester, polyamide, or polyurea prepolymer.

Examples of useful polyols include, but are not limited to, polyester polyols (e.g., lactone polyols) and the alkylene oxide (e.g., ethylene oxide; 1,2-epoxypropane; 1,2-epoxybutane; 2,3-epoxybutane; isobutylene oxide; and epichlorohydrin) adducts thereof, polyether polyols (e.g., polyoxyalkylene polyols, such as polypropylene oxide polyols, polyethylene oxide polyols, polypropylene oxide polyethylene oxide copolymer polyols, and polyoxytetramethylene polyols; polyoxycycloalkylene polyols; polythioethers; and alkylene oxide adducts thereof), polyalkylene polyols, mixtures thereof, and copolymers therefrom. Polyoxyalkylene polyols are particularly useful.

When copolymers are used, chemically similar repeating units may be randomly distributed throughout the copolymer or in the form of blocks in the copolymer. Similarly, chemically similar repeating units may be arranged in any suitable order within the copolymer. For example, oxyalkylene repeating units may be internal or terminal units within a copolymer. The oxyalkylene repeating units may be randomly distributed or in the form of blocks within a copolymer. One example of a copolymer containing oxyalkylene repeating units is a polyoxyalkylene-capped polyoxyalkylene polyol (e.g., a polyoxyethylene-capped polyoxypropylene).

When higher molecular weight polyols (i.e., polyols having weight average molecular weights of at least about 2,000) are used, it is often desirable that the polyol component be “highly pure” (i.e., the polyol approaches its theoretical functionality—e.g., 2.0 for diols, 3.0 for triols, etc.). These highly pure polyols generally have a ratio of polyol molecular weight to weight % monol of at least about 800, typically at least about 1,000, and more typically at least about 1,500. For example, a 12,000 molecular weight polyol with 8 weight % monol has such a ratio of 1,500 (i.e., 12,000/8=1,500). Generally it is desirable that the highly pure polyol contains about 8% by weight monol or less.

Generally, as the molecular weight of the polyol increases in this embodiment, a higher proportion of monol may be present in the polyol. For example, polyols having molecular weights of about 3,000 or less desirably contain less than about 1% by weight of monols. Polyols having molecular weights of greater than about 3,000 to about 4,000 desirably contain less than about 3% by weight of monols. Polyols having molecular weights of greater than about 4,000 to about 8,000 desirably contain less than about 6% by weight of monols. Polyols having molecular weights of greater than about 8,000 to about 12,000 desirably contain less than about 8% by weight of monols.

Examples of highly pure polyols include those available from Lyondell Chemical Company of Houston, Tex., under the trade designation, ACCLAIM, and certain of those under the trade designation, ARCOL.

Where HO-D-OH is a hydroxyl-capped prepolymer, a wide variety of precursor molecules can be used to produce the desired HO-D-OH prepolymer. For example, the reaction of polyols with less than stoichiometric amounts of diisocyanates can produce a hydroxyl-capped polyurethane prepolymer. Examples of suitable diisocyanates include, but are not limited to, aromatic diisocyanates, such as 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate), methylenediphenylene-4,4′-diisocyanate, polycarbodiimide-modified methylenediphenylene diisocyanate, (4,4′-diisocyanato-3,3′,5,5′-tetraethyl)biphenylmethane, 4,4′-diisocyanato-3,3′-dimethoxybiphenyl, 5-chloro-2,4-toluene diisocyanate, 1-chloromethyl-2,4-diisocyanato benzene, aromatic-aliphatic diisocyanates such as m-xylylene diisocyanate, tetramethyl-m-xylylene diisocyanate, aliphatic diisocyanates, such as 1,4-diisocyanatobutane, 1,6-diisocyanatohexane, 1,12-diisocyanatododecane, 2-methyl-1,5diisocyanatopentane, and cycloaliphatic diisocyanates such as methylene-dicyclohexylene-4,4′-diisocyanate, and 3-isocyanatomethyl-3,5,5-trimethyl-cyclohexyl isocyanate (isophorone diisocyanate).

An example of the synthesis of a HO-D-OH prepolymer is shown in Reaction Scheme V (where (CO) represents a carbonyl group C═O, and R⁵ and R⁶ are each independently alkylene, heteroalkylene, or arylene groups) below:

HO—R⁵—OH+OCN—R⁶—NCO→HO—R⁵—O—[(CO)N—R⁶—N(CO)O—R⁵—O—]ₙH Reaction Scheme V

where n is one or greater, depending upon the ratio of polyol to diisocyanate, for example, when the ratio is 2:1, n is 1. Similar reactions between polyols and dicarboxylic acids or dianhydrides can give HO-D-OH prepolymers with ester linking groups.

To prepare the non-siloxane urethane-based reactive oligomers X-A-D-A-X, typically the HO-D-OH compounds are capped with an X-Z compound. The Z group of the X-Z compound is an isocyanate group and the X group is an ethylenically unsaturated group (i.e. a carbon-carbon double bond) and is linked to the Z group. The link between the X and Z groups may be a single bond or it may be a linking group. The linking group may be an alkylene group, a heteroalkylene group, an arylene group, a heteroarylene group, an aralkylene group, or a combination thereof.

Examples of X-Z compounds include a variety of different isocyanato(meth)acrylates such as isocyanatoethyl methacrylate, and m-isopropenyl-α,α-dimethyl benzyl isocyanate. An example of the synthesis of a X-A-D-A-X reactive oligomer where R³ is a substituted or unsubstituted alkylene or arylene, is shown in Reaction Scheme VI below:

HO-D-OH+2OCN—R³—X→X—R³—HN(CO)O-D-O(CO)NH—R³—X Reaction Scheme VI

The D unit in the X-A-D-A-X reactive oligomer is a non-siloxane group that may contain a variety of groups such as urea groups, amide groups, ether groups, carbonyl groups, ester groups, alkylene groups, heteroalkylene groups, arylene groups, heteroarylene groups, aralkylene groups, or combinations thereof. The D unit may also have a variety of molecular weights, depending upon the desired properties of the adhesive formed from the reactive oligomer. Generally, the D unit has a number average molecular weight of 5,000 grams/mole or greater. In some embodiments, the D unit is a heteroalkylene group.

A variety of X-A-D-A-X curable non-siloxane urethane-based reactive oligomers are commercially available. For example, a urethane acrylate oligomer of weight average molecular weight in the range of 4,000-7,000 g/mole is commercially available from Nihon Gosei Kagaku under the trade name “UV-6100B”. Also a variety of urethane oligomers are available from Sartomer Company, Exton, Pa. under the trade names “CN9018”, “CN9002” and “CN9004”.

In some embodiments, the curable composition may by a siloxane-based unit. A wide variety of reactive oligomers containing a siloxane-based unit are suitable for use in preparing the curable composition. Exemplary classes of materials include siloxanes with at least two vinyl groups and siloxane(meth)acrylates.

Examples of useful siloxanes having at least two vinyl groups include vinyl terminated polydimethylsiloxanes having the formula H₂C═CHSiMe₂O(SiMe₂O)ₙSiMe₂CH═CH₂ (CAS 68083-19-2); vinyl terminated dimethylsiloxane-diphenylsiloxane copolymers having the formula H₂C═CHSiMe₂O(SiMe₂O)ₙ(SiPh₂O)ₙSiMe₂CH═CH₂ (CAS: 68951-96-2); vinyl terminated polyphenylmethylsiloxanes having the formula H₂C═CHSiMePhO(SiMePhO)ₙSiMePhCH═CH₂ (CAS: 225927-21-9); vinyl-phenyl-methyl terminated vinylphenylsiloxane-methylphenylsiloxane copolymers (CAS: 8027-82-1); vinyl terminated trifluoropropylmethylsiloxane-dimethylsiloxane copolymers having the formula H₂C═CHSiMePhO(SiMe₂O)ₙ(SiMeCH₂CH₂CF₃O)ₘSiMePhCH═CH₂ (CAS: 68951-98-4); vinyl terminated dimethylsiloxane-diethylsiloxane copolymers having the formula H₂C═CHSiMe₂O(SiMe₂O)ₙ(SiEt₂O)ₙSiMe₂CH═CH₂; trimethylsiloxy terminated vinylmethylsiloxane-dimethylsiloxane copolymers Me₃SiO(SiMe₂O)ₙ(SiMe(CH═CH₂)O)ₘSiMe₃ (CAS: 67762-94-1); vinyl terminated vinylmethylsiloxane-dimethylsiloxane copolymers having the formula H₂C═CH(SiMe₂O)ₙ(SiMeCH═CH₂O)ₘSiMe₂CH═CH₂ (CAS: 68063-18-1); vinylmethylsiloxane homopolymers (cyclic and linear) having the formula Me₃SiO(SiMe(CH═CH₂)O)ₙSiMe₃; and vinyl T-structure polymers having the formula MeSi[O(SiMe₂O)ₘSiMe₂CH═CH₂]₃; all commercially available from vendors such as, for example, Gelest, Inc., Morrisville, Pa. or Dow Corning Corp., Midland, Mich.

In some embodiments, the siloxanes with at least two vinyl groups may be at least partially fluorinated (i.e., be a fluorosilicone). Details concerning preparation of fluorinated siloxanes having at least two vinyl groups may be found in, for example, U.S. Pat. Nos. 4,980,440 (Kendziorski et al.); 4,980,443 (Kendziorski et al.); and 5,356,719 (Hamada et al.). Commercially available fluorosilicones of these types include vinyl terminated (35-45% trifluoropropylmethylsiloxane)-dimethylsiloxane copolymer available from Gelest, Inc., and the vinyl-terminated fluorosilicone that is commercially available under the trade designation “SYL-OFF Q2-7785” from Dow Corning Corp., Midland, Mich.

Another useful class of reactive oligomers with siloxane-based units are siloxane(meth)acrylates. Siloxane(meth)acrylates may be prepared starting from siloxane diamines as described in U.S. Pat. No. 5,264,278 (Mazurek et al.), U.S. Pat. No. 6,441,118 (Sherman et al.) or US Patent Publication No. 2009/0262348 (Mazurek et al.). A number of siloxane(meth)acrylates are also commercially available such as, for example EBECRYL 350 available from Cytec, and TEGO RAD 2250 commercially available from Evonik.

The curable composition mixture may also contain additional free radically polymerizable compounds, and the polymers formed from the curable composition mixture may contain only X-B-X reactive oligomers or they may be copolymers in which additional monomers or reactive oligomers are incorporated. As used herein, additional monomers or reactive oligomers are collectively referred to as ethylenically unsaturated materials.

Among the additional monomers useful for incorporation are monomers which contain ethylenically unsaturated groups and are therefore co-reactive with the reactive oligomers. Examples of such monomers include (meth)acrylates, (meth)acrylamides, alpha-olefins, and vinyl compounds such as vinyl acids, acrylonitriles, vinyl esters, vinyl ethers, styrenes and ethylenically unsaturated oligomers. In some instances more than one type of additional monomer may be used.

Examples of useful (meth)acrylates include alkyl(meth)acrylates, aromatic(meth)acrylates, and silicone acrylates. In applications in which it is desirable that the entire adhesive composition be silicone free, silicone acrylates are generally not used. Alkyl(meth)acrylate monomers are those in which the alkyl groups comprise 1 to about 20 carbon atoms (e.g., from 3 to 18 carbon atoms). Suitable acrylate monomers include, for example, methyl acrylate, ethyl acrylate, n-butyl acrylate, lauryl acrylate, 2-ethylhexyl acrylate, cyclohexyl acrylate, iso-octyl acrylate, octadecyl acrylate, nonyl acrylate, decyl acrylate, and dodecyl acrylate. The corresponding methacrylates are useful as well. An example of an aromatic(meth)acrylate is benzyl acrylate.

Examples of useful (meth)acrylamides, include acrylamide, methacrylamide and substituted (meth)acrylamides such as N,N-dimethyl acrylamide, N,N-dimethyl methacrylamide, N,N-dimethylaminopropyl methacrylamide, N,N-diethylaminopropyl methacrylamide. N,N-dimethylaminoethyl acrylamide, N,N-dimethylaminoethyl methacrylamide, N,N-diethylaminoethyl acrylamide, and N,N-diethylaminoethyl methacrylamide.

The alpha-olefins useful as additional monomers generally include those with 6 or greater carbon atoms. The alpha-olefins with fewer than 6 carbon atoms tend to be too volatile for convenient handling under ambient reaction conditions. Suitable alpha-olefins include, for example, 1-hexene, 1-octene, 1-decene and the like.

Examples of useful vinyl compounds include: vinyl acids such as acrylic acid, itaconic acid, methacrylic acid; acrylonitriles such as acrylonitrile and methacrylonitrile; vinyl esters such as vinyl acetate and the vinyl esters of carboxylic acids such as neodecanoic, neononanoic, neopentanoic, 2-ethylhexanoic, or propionic acids; vinyl ethers such as alkyl vinyl ethers; and styrenes such as styrene or vinyl toluene. Other vinyl compounds that may be useful include N-vinylcaprolactam, vinylidene chloride, N-vinyl pyrrolidone, N-vinyl formamide, and maleic anhydride. For some uses, for example electronic applications, it may be desirable to include vinyl compounds that are free of acidic groups.

Examples of ethylenically unsaturated oligomers useful for copolymerization with the urea-based reactive oligomers include, for example, ethylenically unsaturated silicone oligomers such as are describe in the PCT publication number WO 94/20583 and macromolecular monomers with relatively high glass transition temperatures as described in U.S. Pat. No. 4,554,324 (Husman et al.). In applications in which it is desirable that the entire adhesive composition be silicone free, silicone oligomers are generally not used.

The reaction mixture may also, if desired, contain one or more crosslinking agents. A crosslinking agent is used to build the molecular weight and the strength of the copolymer. Preferably, the crosslinking agent is one that is copolymerized with the non-silicone containing urea-based reactive oligomers and any optional monomers. The crosslinking agent may produce chemical crosslinks (e.g., covalent bonds or ionic bonds). Alternatively, it may produce thermally reversible physical crosslinks that result, for example, from the formation of reinforcing domains due to phase separation of hard segments (i.e., those having a T_{g} higher than room temperature, preferably higher than 70° C.) such as the styrene macromers of U.S. Pat. No. 4,554,324 (Husman) and/or acid/base interactions (i.e., those involving functional groups within the same polymer or between polymers or between a polymer and an additive) such polymeric ionic crosslinking as described in WO 99/42536. Suitable crosslinking agents are also disclosed in U.S. Pat. Nos. 4,737,559 (Kellen), 5,506,279 (Babu et al.), and 6,083,856 (Joseph et al.). The crosslinking agent can be a photocrosslinking agent, which, upon exposure to ultraviolet radiation (e.g., radiation having a wavelength of about 250 nanometers to about 400 nanometers), causes the copolymer to crosslink.

Examples of suitable crosslinking agents include, for example, multifunctional ethylenically unsaturated monomers. Such monomers include, for example, divinyl aromatics, divinyl ethers, multifunctional maleimides, multifunctional acrylates and methacrylates, and the like, and mixtures thereof. Particularly useful are divinyl aromatics such as divinyl benzene and multifunctional (meth)acrylates. Multifunctional (meth)acrylates include tri(meth)acrylates and di(meth)acrylates (that is, compounds comprising three or two (meth)acrylate groups). Typically di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

The crosslinking agent is used in an effective amount, by which is meant an amount that is sufficient to cause crosslinking of the pressure sensitive adhesive to provide adequate cohesive strength to produce the desired final adhesion properties to the substrate of interest. Preferably, the crosslinking agent is used in an amount of about 0.1 part to about 10 parts, based on the total amount of monomers.

Typically, the curable composition also comprises an initiator to initiate free radical polymerization. The initiator may be either a thermal initiator or a photoinitiator. Suitable thermal free radical initiators which may be utilized include, but are not limited to, those selected from azo compounds, such as 2,2′-azobis(isobutyronitrile); hydroperoxides, such as tert-butyl hydroperoxide; and, peroxides, such as benzoyl peroxide and cyclohexanone peroxide. Photoinitiators which are useful include, but are not limited to, those selected from benzoin ethers, such as benzoin methyl ether or benzoin isopropyl ether; substituted benzoin ethers, such as anisole methyl ether; substituted acetophenones, such as 2,2-diethoxyacetophenone and 2,2-dimethoxy-2-phenyl acetophenone; substituted alpha-ketols, such as 2-methyl-2-hydroxy propiophenone; aromatic sulfonyl chlorides, such as 2-naphthalene sulfonyl chloride; and, photoactive oximes, such as 1-phenyl-1,2-propanedione-2-(ethoxycarbonyl)oxime or benzophenone derivatives. Benzophenone derivatives and methods for making them are well known in the art, and are described in, for example, U.S. Pat. No. 6,207,727 (Beck et al.). Exemplary benzophenone derivatives include symmetrical benzophenones (e.g., benzophenone, 4,4′-dimethoxybenzophenone, 4,4′-diphenoxybenzophenone, 4,4′-diphenylbenzophenone, 4,4′-dimethylbenzophenone, 4,4-dichlorobenzophenone); asymmetric benzophenones (e.g., chlorobenzophenone, ethylbenzophenone, benzoylbenzophenone, bromobenzophenone); and free-radically polymerizable benzophenones (e.g., acryloxyethoxybenzophenone). Benzophenone itself is inexpensive, and may be preferable if cost is a factor. Copolymerizable benzophenones may be useful if residual odor or volatiles are a concern, and may be preferable for those applications as they become covalently incorporated into the composition during cure. Examples of useful copolymerizable photoinitiators are disclosed, for example, in U.S. Pat. Nos. 6,369,123 (Stark et al.), 5,407,971 (Everaerts et al.), and 4,737,559 (Kellen et al.). The copolymerizable photocrosslinking agents either generate free radicals directly or abstract hydrogen abstraction atoms to generate free radicals. Examples of hydrogen abstraction type photocrosslinkers include, for example, those based on benzophenones, acetophenones, anthraquinones, and the like. Examples of suitable copolymerizable hydrogen abstraction crosslinking compounds include mono-ethylenically unsaturated aromatic ketone monomers free of orthoaromatic hydroxyl groups. Examples of suitable free-radical generating copolymerizable crosslinking agents include but are not limited to those selected from the group consisting of 4-acryloxybenzophenone (ABP), para-acryloxyethoxybenophenone, and para-N-(methacryloxyethyl)-carbamoylethoxybenophenone. For both thermal- and radiation-induced polymerizations, the initiator is present in an amount of about 0.05% to about 5.0% by weight based upon the total weight of the monomers.

In addition to the reactants, optional property modifying additives can be mixed with the reactive oligomers and optional other monomers provided that they do not interfere with the polymerization reaction. Typical property modifiers include tackifying agents (tackifiers) and plasticizing agents (plasticizers) to modify the adhesive performance of the formed adhesive composition. If used, the tackifiers and plasticizers are generally present in amounts ranging from about 5% to about 55% by weight, about 10 to about 45% by weight or even from about 10% to about 35% by weight.

Useful tackifiers and plasticizers are those conventionally used in the adhesive arts. Examples of suitable tackifying resins include terpene phenolics, alpha methyl styrene resins, rosin derived tackifiers, monomeric alcohols, oligomeric alcohols, oligomeric glycols, and mixtures thereof. Examples of useful plasticizing resins include terpene phenolics, rosin derived plasticizers, polyglycols and mixtures thereof. In some embodiments the plasticizer is isopropyl myristate or a polypropylene glycol.

The curable composition may also be blended with polymers such as pressure sensitive adhesive polymers, to modify the properties of the composition. In some embodiments an acidic pressure sensitive adhesive, such as an acidic (meth)acrylate pressure sensitive adhesive, is blended to form an acid-base interaction with the urea or urethane groups on the non-silicone urea-based or urethane-based adhesive copolymer formed when the curable composition is cured. This acid-base interaction between the polymers is a Lewis acid-base type interaction. Lewis acid-base type interactions require that one component be an electron acceptor (acid) and the other an electron donor (base). The electron donor provides an unshared pair of electrons and the electron acceptor furnishes an orbital system that can accommodate the additional unshared pair of electrons. In this instance acid groups, typically carboxylic acid groups on the added (meth)acrylate pressure sensitive adhesive polymer interact with the unshared electron pairs of the urea or urethane groups of the polymer formed when the curable composition is cured.

Examples of (meth)acrylate pressure sensitive adhesives suitable for adding to the curable composition include (meth)acrylate copolymers prepared from alkyl(meth)acrylate monomers and may contain additional monomers such as vinyl monomers.

Examples of such alkyl(meth)acrylate monomers are those in which the alkyl groups comprise from about 4 carbon atoms to about 12 carbon atoms and include, but are not limited to, n-butyl acrylate, 2-ethylhexyl acrylate, isooctyl acrylate, isononyl acrylate, isodecyl, acrylate, and mixtures thereof. Optionally, other vinyl monomers and alkyl(meth)acrylate monomers which, as homopolymers, have a T_{g} greater than 0° C., such as methyl acrylate, methyl methacrylate, isobornyl acrylate, vinyl acetate, styrene, and the like, may be utilized in conjunction with one or more of the low T_{g} alkyl(meth)acrylate monomers and copolymerizable acidic monomers, provided that the T_{g} of the resultant (meth)acrylate copolymer is less than about 0° C.

When the (meth)acrylate pressure sensitive adhesive is an acidic copolymer, the acidic (meth)acrylate copolymers typically are derived from acidic monomers comprising about 2% by weight to about 30% by weight, or about 2% by weight to about 15% by weight, of a copolymerizable acidic monomer. Examples of useful acidic monomers include (meth)acrylic acid, itaconic acid, crotonic acid, maleic acid, fumaric acid, and the like.

When used, the added pressure sensitive adhesive may be used in any suitable amount to achieve the desired properties of the composition. For example, the added pressure sensitive adhesive may be added in amounts of from about 5 to about 60 weight % of the composition.

In addition, other property modifiers, such as fillers, may be added if desired, provided that if and when incorporated, such additives are not detrimental to the properties desired in the final composition. Fillers, such as fumed silica, fibers (e.g., glass, metal, inorganic, or organic fibers), carbon black, glass or ceramic beads/bubbles, particles (e.g., metal, inorganic, or organic particles), polyaramids (e.g., those available from DuPont Chemical Company; Wilmington, Del. under the trade designation, KEVLAR), and the like which can be added in amounts up to about 30% by weight. Other additives such as dyes, inert fluids (e.g., hydrocarbon oils), pigments, flame retardants, stabilizers, antioxidants, compatibilizers, antimicrobial agents (e.g., zinc oxide), electrical conductors, thermal conductors (e.g., aluminum oxide, boron nitride, aluminum nitride, and nickel particles), and the like can be blended into these systems in amounts of generally from about 1 to about 50 percent by total volume of the composition.

The curable composition may also include one or more solvents. A wide variety of solvents are suitable. Particularly suitable are solvents that do not interfere with the polymerization reaction when the curable composition is cured. Solvents can help reduce the viscosity of the curable composition, permitting it to be more easily coated, and can help in maintaining the fluidity of the composition during curing. Examples of suitable solvents include: alcohols such as methanol, ethanol, isopropanol and the like; aliphatic hydrocarbons such as hexanes, heptanes, petroleum ether and the like; aromatic solvents such as benzene, toluene, and the like; ethers such as diethyl ether, THF (tetrahydrofuran), and the like; esters such as ethyl acetate and the like; ketones such as acetone, MEK (methyl ethyl ketone) and the like.

A variety of different coating methods may be used to coat the first and second fluids onto a substrate. The substrate may comprise any suitable carrier web and typically is flexible. When it is desired to form a transfer tape, the substrate comprises a release liner. If other types of adhesive articles are desired, other types of carrier webs may be used. Examples of such carrier webs include papers and polymeric films. Examples of papers include clay-coated paper and polyethylene-coated paper. Examples of polymeric films include films comprising one or more polymers such as cellulose acetate butyrate; cellulose acetate propionate; cellulose triacetate; poly(meth)acrylates such as polymethyl methacrylate; polyesters such as polyethylene terephthalate, and polyethylene naphthalate; copolymers or blends based on naphthalene dicarboxylic acids; polyether sulfones; polyurethanes; polycarbonates; polyvinyl chloride; syndiotactic polystyrene; cyclic olefin copolymers; and polyolefins including polyethylene and polypropylene such as cast and biaxially oriented polypropylene. The substrate may comprise single or multiple layers, such as polyethylene-coated polyethylene terephthalate. The substrate may be primed or treated to impart some desired property to one or more of its surfaces. Examples of such treatments include corona, flame, plasma and chemical treatments.

In many embodiments, the substrate is a release liner. Any suitable release liner can be used. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like). At least some release liners are coated with a layer of a release agent such as a silicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film. The liner can have a microstructure on its surface that is imparted to the adhesive to form a microstructure on the surface of the adhesive layer. The liner can then be removed to expose an adhesive layer having a microstructured surface.

The coating of the two fluids may be carried out simultaneously or it may be done sequentially. When the coating is carried out sequentially, essentially any fluid coating technique or combination of techniques can be used to coat first the first fluid onto the release liner and then the second fluid onto the first fluid. Examples of suitable coating techniques include, for example, such methods as knife coating, roll coating, gravure coating, rod coating, curtain coating, and air knife coating. The fluid may also be printed by known methods such as screen printing or inkjet printing. In some embodiments, it may be desirable to dry the first fluid coating prior to application of the second fluid coating.

In some embodiments, the multi-layer coating of the two fluids is carried out simultaneously, for example, by simultaneous slot die coating. Additionally, other simultaneous multilayer coating techniques may also be suitable, including, for example, slide coating, curtain coating, fluid bearing die coating, and tandem coating in which two or more fluids are coated simultaneously or nearly simultaneously. Simultaneous coating methods may be advantageous over sequential methods because it can allow a user to prepare a multi-layer article in a single coating step.

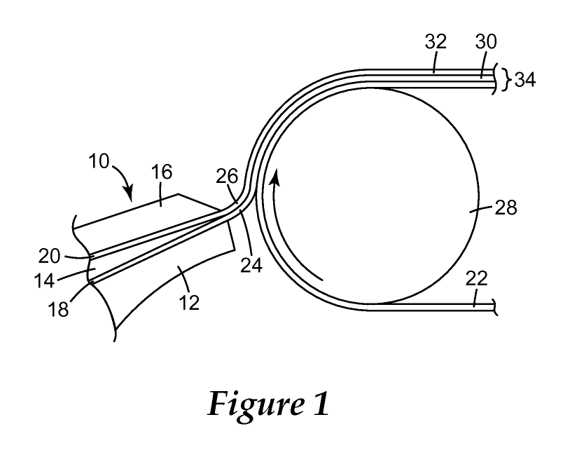

FIG. 1 shows a schematic of an exemplary multi-layer coating method that may be used in this disclosure. Multi-layer coating applicator 10 comprises upstream bar 12, wedge bar 14, and downstream bar 16, and which are juxtaposed to form cavities such as slots or channels within the applicator. First and second coating fluids, 18 and 20, respectively, are supplied by individual pumps (not shown) to the applicator for application to substrate 22. In some embodiments, substrate 22 is a release substrate such as release liner or a release film. The first coating fluid 18 forms continuous flowing layer 24. The second coating fluid flows from the applicator and forms continuous flowing layer 26 on the surface of continuous first flowing layer 24. The substrate is continuously moved through the coating station, in the direction shown by the arrow, on the peripheral surface of backup roller 28 by a conveyance means (not shown). The first and second coated layers, 30 and 32, respectively, on release substrate 22 comprise multi-layer coated article 34.

The multi-layer coating applicator shown in FIG. 1 is a type of extrusion applicator, particularly referred to as a slotted die applicator or coater with the fluids being fed in a pre-metered fashion through adjustable slots. Slotted die coaters typically have one slot for coating a fluid situated near and about parallel to a second slot for coating a second fluid with the orifices located near the moving substrate. The flow of each fluid through the respective slots can be controlled with shims. Use of this type of applicator is disclosed, for example, in U.S. Pat. Nos. 5,759,274; 5,639,305; 5,741,549; 6,720,025 B2; and 7,097,673 B2.

Any type of multi-layer coating applicator may be used to carry out the multi-layer coating method disclosed herein provided it can deliver two different fluids in contact with one another to form a continuously flowing layer, and as long as the coater permits the fluids to be coated on a substrate at the same time or nearly the same time. Preferably, the multi-layer coating applicator delivers both fluids in a pre-metered fashion. Useful applicators are described, for example, in Cohen, E. and Gutoff, E. Modern Coating and Drying Technology; VCH Publishers: New York, 1992; and in Liquid Film Coating; Kistler, S. F. and Schweizer, P. M., Eds.; Chapman & Hall: London, 1997. These references also describe useful designs for coating apparatuses that may be employed.

For the multi-layer method disclosed herein, a composite flowing layer is formed by flowing first and second coating fluids at a rate sufficient to form a continuous flowing composite layer on a substrate. The composite flowing layer is then deposited onto the substrate as it passes through a coating station with the first coating fluid layer between the second coating fluid layer and the substrate.

The continuous flowing layer is formed by flowing the coating fluids at some minimum rate or higher that allows the coating fluids to achieve sufficient velocity and break cleanly from the applicator. Other controllable factors include the design of the applicator, for example, dimensions of the slots or channels through which the fluids flow, the distance between the applicator and the substrate, and the angle of approach of the applicator with respect to the substrate. Additional factors to consider are substrate (line) speed and whether or not vacuum is applied.

Typically, a dry coating weight per unit area for the second layer is initially targeted and correlated to a desired wet coating weight per unit area, or desired coating weight per unit area of the layer before any solvent has evaporated. (Dry and wet coating thicknesses may also be used, although densities of dry coatings are typically limited.) Generally, as will be recognized by one of ordinary skill, there is a window of operability that exists, and this window can limit the wet coating weight per unit area that is coatable depending on the particular applicator and the factors described above. This window of operability is used to determine the actual coating weight per unit area for the second coating fluid and the parameters used to set up the coating process. Accordingly, the concentration of components in the second coating fluid can also be varied.

The substrate is contacted with the composite flowing layer such that the first and second coating layers are coated simultaneously or substantially simultaneously. The individual fluid layers of the composite flowing layer can impinge on the substrate with little or no mixing such that the distinct properties of the layers are maintained. If this is desired, turbulence in the individual layers should be minimized if the interfacial tensions are low or if the layers are miscible. If there is high interfacial tension, some turbulence may occur without disrupting the interface.

The substrate is moved through the coating station at a speed sufficient to allow an economically productive manufacturing rate and provide a stable coating without instabilities. Preferably, the speed is maintained at a rate that minimizes air entrainment (such as what can occur at high substrate speed). The speed at which the substrate is moved, also referred to as the coating speed, depends on a variety of factors which define the window of operability as described above.

After the two fluid layers are coated on a release liner, the formed laminate construction may be, and generally is, dried to remove any solvent and/or water present in the fluid layers. This drying is typically done by exposing the laminate construction to elevated temperature in, for example, a forced air oven. It generally is desirable to remove residual solvent and/or other volatile components prior to use of the adhesive layer, especially in optical applications, as volatiles present in the adhesive matrix can cause bubbles and other optical imperfections.

After the multi-layer laminate construction is dried, the curable composition in the second layer is cured, i.e. polymerized, to form the second pressure sensitive adhesive layer. Typically, the polymerization is initiated by activating the initiator present in the curable composition, either thermally or photochemically. Thermal activation can be achieved by placing the coated release liner in an oven, such as a forced air oven, or thermal activation can be achieved through the use of a radiative heat source, such as, for example, an infrared lamp. If a thermal initiator is used, initiation may be carried out simultaneous with drying. Photochemical activation can be achieved through the use of, for example, a UV lamp, such as a high intensity UV curing system such as are available from Fusion UV Systems Gaithersburg, Md. Such systems can produce UV light with an intensity of 300-600 Watts per inch.

Also disclosed herein are double-sided multi-layer adhesives. These adhesives comprise a first pressure sensitive adhesive layer and a second pressure sensitive adhesive layer. The second pressure sensitive adhesive is formed by curing a curable reaction mixture as described above. The method described above can be used to form a wide variety of adhesive articles. If the substrate on which the pressure sensitive adhesive layers are coated is a release liner, the formed article is a transfer tape. The transfer tape article can be laminated to a variety of different substrates to form additional articles. Alternatively, if the substrate to which the pressure sensitive adhesive layers are coated is not a release liner, a variety of different articles can be prepared directly.

In some embodiments, the resulting articles can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, screens or displays, cathode ray tubes, polarizers, reflectors, lighting elements, solar elements, windows, protective films, and the like.

Any suitable optical film can be used in the articles. As used herein, the term “optical film” refers to a film that can be used to produce an optical effect. The optical films are typically polymer-containing films that can be a single layer or multiple layers. The optical films are flexible and can be of any suitable thickness. The optical films often are at least partially transmissive, reflective, antireflective, polarizing, optically clear, or diffusive with respect to some wavelengths of the electromagnetic spectrum (e.g., wavelengths in the visible ultraviolet, or infrared regions of the electromagnetic spectrum). Exemplary optical films include, but are not limited to, visible mirror films, color mirror films, solar reflective films, infrared reflective films, ultraviolet reflective films, reflective polarizer films such as a brightness enhancement films and dual brightness enhancement films, absorptive polarizer films, optically clear films, tinted films, and antireflective films.

In some embodiments the optical film has a coating. In general, coatings are used to enhance the function of the film or provide additional functionality to the film. Examples of coatings include, for example, hardcoats, anti-fog coatings, anti-scratch coatings, privacy coatings or a combination thereof. Coatings such as hardcoats, anti-fog coatings, and anti-scratch coatings that provide enhanced durability, are desirable in applications such as, for example, touch screen sensors, display screens, graphics applications and the like. Examples of privacy coatings include, for example, blurry or hazy coatings to give obscured viewing or louvered films to limit the viewing angle.

Some optical films have multiple layers such as multiple layers of polymer-containing materials (e.g., polymers with or without dyes) or multiple layers of metal-containing material and polymeric materials. Some optical films have alternating layers of polymeric material with different indexes of refraction. Other optical films have alternating polymeric layers and metal-containing layers. Exemplary optical films are described in the following patents: U.S. Pat. No. 6,049,419 (Wheatley et al.); U.S. Pat. No. 5,223,465 (Wheatley et al.); U.S. Pat. No. 5,882,774 (Jonza et al.); U.S. Pat. No. 6,049,419 (Wheatley et al.); U.S. Pat. No. RE 34,605 (Schrenk et al.); U.S. Pat. No. 5,579,162 (Bjornard et al.), and U.S. Pat. No. 5,360,659 (Arends et al.).

The first pressure sensitive adhesive generally comprises a polymeric and/or oligomeric adhesive prepared by polymerizing one or more monomers. Examples of suitable pressure sensitive adhesives include (meth)acrylate pressure sensitive adhesives and siloxane pressure sensitive adhesives. In some embodiments, particularly embodiments involving optical elements and optical applications, it is desirable that the first pressure sensitive adhesive be optically clear. Examples of suitable first pressure sensitive adhesives are presented above.

A variety of thicknesses are suitable for the first and second pressure sensitive adhesive layers. The pressure sensitive adhesives may have the same or similar thicknesses, or one layer may be a thicker layer. Typically, the first pressure sensitive adhesive layer is thicker than the second pressure sensitive adhesive layer. The first pressure sensitive adhesive layer ranges in thickness from about 10 to about 100 micrometers.

The second pressure sensitive adhesive layer comprises a cured mixture. The cured mixture comprises at least one segmented polymer that may be urea-based or urethane-based. The polymer may comprise a homopolymer, where the cured mixture is formed from a single reactive compound, or the cured mixture may comprise a copolymer, where the cured mixture is formed from more than one reactive compound. Typically the second pressure sensitive adhesive layer comprises a copolymer. The non-silicone containing segmented urea-based oligomers and non-silicone containing segmented urethane-based oligomers used to prepare the urea-based or urethane-based second pressure sensitive adhesive layers are described in further detail above.

Besides the polymer, the second pressure sensitive adhesive layer may comprise a variety of additives. The additive may comprise a pressure sensitive adhesive, a plasticizing agent, a tackifying agent, a UV stabilizer, an environmental stabilizer, or the like or combinations and mixtures thereof. In some embodiments, the second pressure sensitive adhesive layer composition comprises 5-60 weight % of cured reaction mixture and 5-55 weight % plasticizer. Descriptions of suitable plasticizers as well as additional suitable additives are described as components of the second fluid.

While in some embodiments the second pressure sensitive adhesive may be the same thickness or even thicker than the first pressure sensitive adhesive layer, the second pressure sensitive adhesive layer is typically thinner than the first pressure sensitive adhesive layer. The second pressure sensitive adhesive layer generally ranges in thickness from about 5 to about 50 micrometers.

The second pressure sensitive adhesive layer may have a variety of desirable properties, including properties not present in the first pressure sensitive adhesive layer. In this way, the properties of the first pressure sensitive adhesive layer can be modified by the presence of a relatively thin layer of the second pressure sensitive adhesive layer.

In some embodiments the second pressure sensitive adhesive layer is optically transparent or even optically clear. If the first pressure sensitive adhesive layer is also optically transparent of optically clear, the entire adhesive may be optically clear or optically transparent and therefore suitable for use in optical applications.

In some embodiments, the second pressure sensitive adhesive layer is a self-wetting and removable adhesive layer. The adhesives exhibit great conformability permitting them to spontaneously wet out substrates. The surface characteristics also permit the adhesives to be bonded and removed from the substrate repeatedly for repositioning or reworking. The strong cohesive strength of the adhesives gives them structural integrity limiting cold flow and giving elevated temperature resistance in addition to permanent removability.

Exemplary adhesive articles in which the self wetting and removability features are especially important include, for example: large format articles such as graphic articles and protective films; and information display devices.

Large-format graphic articles or protective films typically include a thin polymeric film backed by a pressure sensitive adhesive. These articles may be difficult to handle and apply onto a surface of a substrate. The large format article may be applied onto the surface of a substrate by what is sometimes called a “wet” application process. The wet application process involves spraying a liquid, typically a water/surfactant solution, onto the adhesive side of the large format article, and optionally onto the substrate surface. The liquid temporarily “detackifies” the pressure sensitive adhesive so the installer may handle, slide, and re-position the large format article into a desired position on the substrate surface. The liquid also allows the installer to pull the large format article apart if it sticks to itself or prematurely adheres to the surface of the substrate. Applying a liquid to the adhesive may also improve the appearance of the installed large format article by providing a smooth, bubble free appearance with good adhesion build on the surface of the substrate.

Examples of a large format protective films include window films such as solar control films, shatter protection films, decoration films and the like. In some instances the film may be a multi-layer film such as a multi-layer IR film (i.e., an infrared reflecting film), such as a microlayer film having selective transmissivity such as an optically clear but infrared reflecting film as described in U.S. Pat. No. 5,360,659 (Arends et al.).

While the wet application process has been used successfully in many instances, it is a time consuming and messy process. A “dry” application process is generally desirable for installing large format graphic articles. Adhesives that are self wetting and removable may be applied with a dry installation process. The articles are easily attached to a large substrate because they are self wetting and yet they may be easily removed and repositioned as needed.

In other applications, such as information display devices, the wet application process cannot be used. Examples of information display devices include devices with a wide range of display area configurations including liquid crystal displays, plasma displays, front and rear projection displays, cathode ray tubes and signage. Such display area configurations can be employed in a variety of portable and non-portable information display devices including personal digital assistants, cell phones, touch-sensitive screens, wrist watches, car navigation systems, global positioning systems, depth finders, calculators, electronic books, CD or DVD players, projection television screens, computer monitors, notebook computer displays, instrument gauges, instrument panel covers, signage such as graphic displays (including indoor and outdoor graphics, bumper stickers, etc) reflective sheeting and the like.

A wide variety of information display devices are in use, both illuminated devices and non-illuminated devices. Many of these devices utilize adhesive articles, such as adhesive coated films, as part of their construction. One adhesive article frequently used in information display devices is a protective film. Such films are frequently used on information display devices that are frequently handled or have exposed viewing surfaces.

In some embodiments, the adhesives of this disclosure may be used to attach such films to information display devices because the adhesives have the properties of optical clarity, self wetting and removability. The adhesive property of optical clarity permits the information to be viewed through the adhesive without interference. The features of self wetting and removability permit the film to be easily applied to display surface, removed and reworked if needed during assembly and also removed and replaced during the working life of the information display device.

The present disclosure includes the following embodiments.

Among the embodiments are methods for preparing double-sided multi-layer adhesives. A first embodiment includes a method of preparing an double-sided multi-layer adhesive comprising: providing a first fluid comprising a polymeric adhesive composition solution or dispersion; providing a second fluid comprising a curable composition comprising: at least one X-B-X reactive oligomer, wherein X comprises an ethylenically unsaturated group, and B comprises a non-siloxane containing segmented urea-based unit, a non-siloxane containing segmented urethane-based unit, or a siloxane-based unit, and an initiator; coating the first fluid and the second fluid onto a substrate; and curing the curable composition.

Embodiment 2 is the method of embodiment 1, wherein coating the first fluid and the second fluid onto a substrate comprises simultaneous slot die coating of the two fluids.

Embodiment 3 is the method of embodiment 2, wherein the second fluid is coated over a coating of the first fluid.

Embodiment 4 is the method of embodiment 1, wherein the coating the first fluid and the second fluid onto a substrate comprises sequential coating wherein the second fluid is coated over the first fluid.

Embodiment 5 is the method of any of embodiments 1-4, further comprising drying of the cured composition.

Embodiment 6 is the method of embodiment 1, wherein the polymeric adhesive composition comprises a pressure sensitive adhesive.

Embodiment 7 is the method of embodiment 6, wherein the pressure sensitive adhesive comprises a poly(meth)acrylate, or a siloxane.

Embodiment 8 is the method of embodiment 1, wherein the X-B-X reactive oligomer is the reaction product of a non-siloxane containing segmented urea-based diamine and a Z-X molecule, wherein X comprises an ethylenically unsaturated group, and Z comprises an amine-reactive group.

Embodiment 9 is the method of embodiment 1, wherein the X-B-X reactive oligomer is the reaction product of a non-siloxane containing segmented urea-based diamine and a Z-W-Z material, wherein Z comprises an amine-reactive group and W comprises a linking group, followed by the reaction with a Y-X material wherein X comprises an ethylenically unsaturated group, and Y comprises an Z-reactive group.

Embodiment 10 is the method of embodiment 9, wherein Z-W-Z comprises a diisocyanate and Y-X comprises a hydroxyl-functional (meth)acrylate.

Embodiment 11 is the method of embodiment 1, wherein the curable composition further comprises a pressure sensitive adhesive, a plasticizing agent, a tackifying agent or mixture thereof.

Embodiment 12 is the method of embodiment 11, wherein the curable composition further comprises 5-55 weight % plasticizer.

Embodiment 13 is the method of any of embodiments 1-12, wherein the substrate comprises a release liner.

Embodiment 14 is the method of embodiment 13, wherein the release liner comprises a microstructured surface.

Embodiment 15 is the method of any of embodiments 1-12, wherein the substrate comprises an optical film.

Embodiment 16 is the method of embodiment 15, wherein the optical film comprises a visible mirror film, a color mirror film, a solar reflective film, a diffusive film, an infrared reflective film, an ultraviolet reflective film, a reflective polarizer film such as a brightness enhancement film or a dual brightness enhancement film, an absorptive polarizer film, an optically clear film, a tinted film, or an antireflective film.

Embodiment 17 is the method of embodiment 15, wherein the optical film comprises a solar control film.

Embodiment 18 is the method of any of embodiments 1-17, further comprising applying a second substrate to the cured composition.

Embodiment 19 is the method of embodiment 18, wherein the second substrate comprises a microstructured surface.

Among the embodiments are double-sided multi-layer adhesives. Embodiment 20 comprises: at least two layers of pressure sensitive adhesive, the first layer comprising a first pressure sensitive adhesive composition; and the second layer comprising a second pressure sensitive adhesive composition comprising a cured mixture comprising: at least one X-B-X reactive oligomer, wherein X comprises an ethylenically unsaturated group, and B comprises a non-siloxane containing segmented urea-based unit, or a non-siloxane containing segmented urethane-based unit.

Embodiment 21 is the double-sided multi-layer adhesive of embodiment 20, wherein B comprises a non-siloxane containing segmented urea-based unit that comprises at least one urea group and at least one oxyalkylene group.

Embodiment 22 is the double-sided multi-layer adhesive of embodiments 20 or 21, wherein the X-B-X reactive oligomer is the reaction product of a non-siloxane segmented urea-based diamine and a Z-X material, wherein X comprises an ethylenically unsaturated group, and Z comprises an amine-reactive group.

Embodiment 23 is the double-sided multi-layer adhesive of embodiment 22, wherein the non-siloxane segmented urea-based diamine is the reaction product of a polyoxyalkylene diamine with a diaryl carbonate.

Embodiment 24 is the double-sided multi-layer adhesive of embodiment 22, wherein Z comprises an isocyanate, an azlactone, an anhydride or a combination thereof.

Embodiment 25 is the double-sided multi-layer adhesive of embodiment 20, wherein the X-B-X reactive oligomer is the reaction product of a non-siloxane segmented urea-based diamine and a Z-W-Z material, wherein Z comprises an amine-reactive group and W comprises a linking group, followed by the reaction with a Y-X material wherein X comprises an ethylenically unsaturated group, and Y comprises an Z-reactive group.

Embodiment 26 is the double-sided multi-layer adhesive of embodiment 25, wherein Z-W-Z comprises a diisocyanate and Y-X comprises a hydroxyl-functional (meth)acrylate.

Embodiment 27 is the double-sided multi-layer adhesive of embodiment 20, wherein B comprises a non-siloxane segmented urethane-based unit that comprises at least one urethane group and at least one oxyalkylene group.

Embodiment 28 is the double-sided multi-layer adhesive of embodiment 20, wherein X-B-X comprises a siloxane diacrylate.

Embodiment 29 is the double-sided multi-layer adhesive of any of embodiments 20-28, wherein the adhesive is an optically clear adhesive.

Embodiment 30 is the double-sided multi-layer adhesive of any of embodiments 20-29, wherein the first layer is a self-wetting and removable adhesive.

Embodiment 31 is the double-sided multi-layer adhesive of any of embodiments 20-30, wherein at least one layer is a microstructured adhesive.

Embodiment 32 is the double-sided multi-layer adhesive of any of embodiments 20-31, wherein the cured mixture further comprises an ethylenically unsaturated material.

Embodiment 33 is the double-sided multi-layer adhesive of any of embodiments 20-32, wherein at least one of the first layer or the second layer further comprises an additive, wherein the additive comprises a pressure sensitive adhesive, a plasticizing agent, a tackifying agent, a UV stabilizer, an environmental stabilizer, or mixture thereof.

Embodiment 34 is the double-sided multi-layer adhesive of embodiment 33, wherein the first layer pressure sensitive adhesive composition comprises 5-60 weight % of cured reaction mixture and 5-55 weight % plasticizer.

Embodiment 35 is the double-sided multi-layer adhesive of any of embodiments 20-34, wherein the second layer comprises poly(meth)acrylate, or a siloxane.

Embodiment 36 is the double-sided multi-layer adhesive of any of embodiments 20-35, wherein the second layer has a 180° Peel Strength which is less than the 180° Peel Strength of the first layer as measured by ASTM test method ASTM D3330-90.

Among the embodiments are adhesive articles. Embodiment 37 comprises: a double-sided multi-layer adhesive comprising at least two layers of pressure sensitive adhesive, the first layer comprising a first pressure sensitive adhesive; and the second layer comprising: a pressure sensitive adhesive comprising a cured mixture comprising: at least one X-B-X reactive oligomer, wherein X comprises an ethylenically unsaturated group, and B comprises a non-siloxane containing segmented urea-based unit, or a non-siloxane containing urethane-based unit; and a substrate.

Embodiment 38 is the adhesive article of embodiment 37, wherein the substrate comprises an optically active film comprising a visible mirror film, a color mirror film, a solar reflective film, a diffusive film, an infrared reflective film, an ultraviolet reflective film, a reflective polarizer film such as a brightness enhancement film or a dual brightness enhancement film, an absorptive polarizer film, an optically clear film, a tinted film, or an antireflective film.

Embodiment 39 is the adhesive article of embodiment 38, wherein the optically active film comprises a solar control film.

Embodiment 40 is the adhesive article of embodiment 38 or 39, wherein the optically active film comprises a coated film wherein the coating comprises a hardcoat, an anti-fog coating, an anti-scratch coating, a privacy coating or combination thereof.

Embodiment 41 is the adhesive article of any of embodiments 38-40, wherein the non-siloxane segmented urea-based unit comprises at least one urea group and at least one oxyalkylene group.

Embodiment 42 is the adhesive article of any of embodiments 38-41, further comprising a second substrate, wherein the second substrate comprises a rigid surface, a flexible surface, a tape backing, a film, a sheet, or a release liner.

Embodiment 43 is the adhesive article of any of embodiments 38-42, wherein the second layer comprises a poly(meth)acrylate pressure sensitive adhesive, or a polysiloxane pressure sensitive adhesive.

Embodiment 44 is the adhesive article of embodiment 42, wherein the second substrate comprises a microstructured surface.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

Table of Abbreviations

| Abbreviation | |
|---|---|
| or Trade | Description |
| Designation | |
| FCF-1 | First Coating Fluid-1, a pre-polymerized monomer blend of isooctyl |
| | acrylate (IOA), methyl acrylate (MA), and acrylic acid (AA) in an |
| | approximate ratio of IOA/MA/AA of 57.5/35/7.5 as a 25% by weight |
| | solids solution in an ethyl acetate/toluene solvent blend. |
| SCF-1 | Second Coating Fluid-1, curable solution mixture of: 30 parts by |
| | weight methacrylated extended polyether (MAcEPE) described in |
| | PCT Publication WO2009/085662; 10 parts by weight tripropyl glycol |
| | diacrylate (commercially available from Sartomer Co. as Sr306F); 10 |
| | parts by weight dipentaerythritol pentacrylate (commercially available |
| | from Sartomer Co. as Sr399); 25 parts by weight isopropyl myristate; |
| | 25 parts by weight FCF-1 as described above; 2 parts by weight |
| | photoinitiator (commercially available from Ciba as DAROCUR 4265); |
| | as a 35% solids solution in an ethyl |
| | acetate/isopropanol/methoxypropanol solvent blend. |
| Release Liner | Silicone coated polyethylene terephthalate release liner of 22.9 |
| | centimeter (9 inch) width commercially available from CP Films, |
| | Martinsville, VA as “T-10”. |
| PET Film | Polyethylene terephthalate film, 22.9 cm (9 inch) wide, 0.05 mm |
| | (0.002 inch) thick, commercially available as 597197 SCOTCHPAR |
| | Film from 3M Company, St. Paul, MN. |

### Examples 1-2 and Comparative Examples C1-C2

For each Example two layer coatings and for each Comparative Example single layer coatings, were prepared using the following general procedure. A 22.9 centimeter wide web of Release Liner was conveyed at a line speed of 3.04 meters/minute (10 feet/minute) around a 25.4 centimeter (10 inch) diameter stainless steel back-up roller. A dual slot coater equipped with a die as described in FIG. 2b of U.S. Pat. No. 7,097,673 B2 was used with FCF-1 coating fluid coated from the first slot and SCF-1 coating fluid coated from the second slot. The position of the die was adjusted relative to the Release Liner surface such that the minimum gap was at least the total wet thickness of the first and second coated layers. The die openings were set so slot heights were 0.375 millimeter (0.015 inch) for slot 1 and 0.175 millimeter (0.007 inch) for slot 2. Each slot width was 15.225 centimeters (6 inches). A continuous uniform layer of the two coating fluids on the Release Liner was obtained. Layer thicknesses and flow rates for the pumps are shown in Table 1 below. The coated layers on the Release Liner were subsequently dried in 3 temperature zones of 66° C. (150° F.) over a length of 9.2 meters (30 feet). The dried coatings were then passed through a Fusion UV curing system (commercially available from Fusion UV System, Gaithersburg, Md.) with an exposure of 236 Watts per centimeter (600 Watts per inch), to cure the SCF-1 layer. A sample of PET Film was laminated to the exposed surface of the dried and cured SCF-1 layer, and the resulting laminate was wound into a roll.

TABLE 1

| | | | Wet | Wet | Dry | Dry | |
|---|---|---|---|---|---|---|---|
| | Flow | Flow | Thickness | Thickness | Thickness | Thickness | |
| | Rate | Rate | First | Second | First | Second | Total Dry |
| | FCF | SCF-1 | Layer | Layer | Layer | Layer | Thickness |
| Example | (g/min) | (g/min) | (μm) | (μm) | (μm) | (μm) | (μm) |
| C1 | 0 | 78 | 0 | 160.0 | 0 | 56.0 | 56.0 |
| 1 | 29 | 44 | 66.4 | 90.2 | 17.3 | 31.6 | 48.9 |
| 2 | 29 | 40 | 66.4 | 81.2 | 17.3 | 40.6 | 57.9 |
| C2 | 29 | 0 | 66.4 | 0 | 17.3 | 0 | 17.3 |

1. A double-sided multi-layer adhesive comprising:
at least two layers of pressure sensitive adhesive,
the first layer comprising a first pressure sensitive adhesive composition; and
the second layer comprising a second pressure sensitive adhesive composition comprising a cured mixture comprising:
at least one X-B-X reactive oligomer, wherein X comprises an ethylenically unsaturated group, and B comprises a non-siloxane containing segmented urea-based unit, or a non-siloxane containing segmented urethane-based unit.

2. The double-sided multi-layer adhesive of claim 1, wherein B comprises a non-siloxane containing segmented urea-based unit that comprises at least one urea group and at least one oxyalkylene group.

3. The double-sided multi-layer adhesive of claim 2, wherein the X-B-X reactive oligomer is the reaction product of a non-siloxane segmented urea-based diamine and a Z-X material, wherein X comprises an ethylenically unsaturated group, and Z comprises an amine-reactive group.

4. The double-sided multi-layer adhesive of claim 3, wherein the non-siloxane segmented urea-based diamine is the reaction product of a polyoxyalkylene diamine with a diaryl carbonate.

5. The double-sided multi-layer adhesive of claim 3, wherein Z comprises an isocyanate, an azlactone, an anhydride or a combination thereof.

6. The double-sided multi-layer adhesive of claim 1, wherein the X-B-X reactive oligomer is the reaction product of a non-siloxane segmented urea-based diamine and a Z-W-Z material, wherein Z comprises an amine-reactive group and W comprises a linking group, followed by the reaction with a Y-X material wherein X comprises an ethylenically unsaturated group, and Y comprises an Z-reactive group.

7. The double-sided multi-layer adhesive of claim 6, wherein Z-W-Z comprises a diisocyanate and Y-X comprises a hydroxyl-functional (meth)acrylate.

8. The double-sided multi-layer adhesive of claim 1, wherein the adhesive is an optically clear adhesive.

9. The double-sided multi-layer adhesive of claim 1, wherein the first layer is a self-wetting and removable adhesive.

10. The double-sided multi-layer adhesive of claim 1, wherein at least one layer is a micro structured adhesive.

11. (canceled)

12. The double-sided adhesive tape of claim 1, wherein at least one of the first layer or the second layer further comprises an additive, wherein the additive comprises a pressure sensitive adhesive, a plasticizing agent, a tackifying agent, a UV stabilizer, an environmental stabilizer, or mixture thereof.

13. The double-sided adhesive tape of claim 2, wherein the first layer pressure sensitive adhesive composition comprises 5-60 weight % of cured reaction mixture and 5-55 weight % plasticizer.

14. (canceled)

15. (canceled)

16. The double sided adhesive tape of claim 1, wherein the second layer comprises poly(meth)acrylate, a siloxane, or a siloxane(meth)acrylate.

17. The double-sided adhesive tape of claim 1, wherein the second layer has a 180° Peel Strength which is less than the 180° Peel Strength of the first layer as measured by ASTM test method D 3330-90.

18. A method of preparing an double-sided multi-layer adhesive comprising:
providing a first fluid comprising a polymeric adhesive composition solution or dispersion;
providing a second fluid comprising a curable composition comprising:
at least one X-B-X reactive oligomer, wherein X comprises an ethylenically unsaturated group, and B comprises a non-siloxane containing segmented urea-based unit, a non-siloxane containing segmented urethane-based unit, or a siloxane-based unit, and an initiator;
coating the first fluid and the second fluid onto a substrate; and
curing the curable composition.

19. The method of claim 18, wherein coating the first fluid and the second fluid onto a substrate comprises simultaneous slot die coating of the two fluids.

20. The method of claim 19, wherein the second fluid is coated over a coating of the first fluid.

21.-26. (canceled)

27. The method of claim 18, wherein the curable composition further comprises a pressure sensitive adhesive, a plasticizing agent, a tackifying agent or mixture thereof.

28. (canceled)

29. An adhesive article comprising:
a double-sided multi-layer adhesive comprising at least two layers of pressure sensitive adhesive,
the first layer comprising a first pressure sensitive adhesive; and
the second layer comprising:
a pressure sensitive adhesive comprising a cured mixture comprising:
at least one X-B-X reactive oligomer, wherein X comprises an ethylenically unsaturated group, and B comprises a non-siloxane containing segmented urea-based unit, or a non-siloxane containing urethane-based unit; and
a substrate.

30. The adhesive article of claim 29 wherein the substrate comprises an optically active film comprising a visible mirror film, a color mirror film, a solar reflective film, a diffusive film, an infrared reflective film, an ultraviolet reflective film, a reflective polarizer film such as a brightness enhancement film or a dual brightness enhancement film, an absorptive polarizer film, an optically clear film, a tinted film, or an antireflective film.
